(19) United States
(12) Patent Application Publication
(10) Pub. No.: US 2026/0098934 A1
(43) Pub. Date: Apr. 9, 2026

(54) RADAR TRANSCEIVER DEVICE FOR RADAR SIGNALS

(71) Applicant: Robert Bosch GmbH, Stuttgart (DE)

(72) Inventors: Daniel Schindler, Korntal-Münchingen (DE); Werner Soergel, Pforzheim (DE)

(21) Appl. No.: 19/279,326

(22) Filed: Jul. 24, 2025

(30) Foreign Application Priority Data
Oct. 7, 2024 (DE) 10 2024 209 737.3

(51) Int. Cl. G01S 7/03; G01S 7/35; G01S 13/32; H01Q 1/36

(52) U.S. Cl. CPC G01S 7/03; G01S 7/35; G01S 13/32; H01Q 1/36

(57) ABSTRACT

A radar transceiver device for radar signals with a frequency-selective radar transmitting unit and/or with a frequency-selective radar receiving unit. The frequency-selective radar transmitting unit has a digital-to-analog converter to convert a broadband digital signal provided for all transmission channels into an analog transmission signal, a signal modulator which modulates a signal carrier with the analog transmission signal emitted by the digital-to-analog converter, and at least one frequency-selective component to partition the transmission signal modulated by the signal modulator to a plurality of transmission channels for emission as a radar signal. The frequency-selective radar receiving unit includes a frequency-selective component to combine a received radar signal including a plurality of receive channels, a signal demodulator which demodulates the radar signal combined by the frequency-selective component using a signal carrier, and at least one analog-to-digital converter.

### CROSS REFERENCE

The present application claims the benefit under 35 U.S.C. § 119 of Germany Patent Application No. DE 102024 209 737.3 filed on October 7, 2024, which is expressly incorporated herein by reference in its entirety.

### FIELD

The present invention relates to a radar transceiver device for radar signals and in particular to a sensor design for radar devices with broadband digital signal generation and frequency-selective TX/RX behavior.

### BACKGROUND INFORMATION

A radar detects objects using electromagnetic or radio waves. The radar can measure not only the distance, but in the case of moving objects also the angle and relative speed to the target object.

Germany Patent Application No. DE 102013222963 A1 relates to a radar antenna comprising a primary radiator, a waveguide element and a lens, wherein the waveguide element is designed and arranged between the primary radiator and the lens in such a way that the cross-sectional surface of the waveguide element on a side facing the primary radiator is smaller than the cross-sectional surface of the waveguide element on an opposite side facing away from the primary radiator. It is essential that the primary radiator is designed as an edge-emitting antenna and that the waveguide element is designed and arranged to cooperate with the edge-emitting antenna in such a way that the waveguide element, at its end facing the edge-emitting antenna, overlaps the edge-emitting antenna at an upper side and at an opposite lower side of the edge-emitting antenna.

Germany Patent Application No. DE 112018001287 T5 relates to a radar technology for measuring distance or relative speed using a frequency modulation method. This allows the distance resolution to be increased while preventing a deterioration of the signal-to-noise ratio. The radar circuit includes a signal generation unit that generates a transmission signal for a transmission wave, a modulation control unit that controls frequency modulation of the transmission signal, a reception-side circuit unit that detects a detection signal based on a difference frequency between a reception signal of a reception wave and the transmission signal, and a signal processing unit that performs analysis processing based on the detection signal and calculates the distance and the relative speed.

Germany Patent Application No. DE 102019201374 A1 relates to a method for operating a plurality of radar sensors in a radar network, in which the transmitted FMCW radar signals are each preceded by a CW signal containing binary-coded information about transmission parameters of the transmitting radar sensor and/or further information. In a preferred embodiment, each radar sensor receives corresponding CW signals with information about transmission parameters of other radar sensors in the radar network, processes the information and, upon detection of a match, adjusts its own transmission parameters so that they no longer match the transmission parameters of the other radar sensors. The method enables interference-free operation of a plurality of radar sensors in a radar network and can also be used with a multi-static radar.

Germany Patent Application No. DE 102022205109 A1 relates to an electronic device which can include a voltage standing wave ratio (VSWR) sensor arranged along a high-frequency transmission line between a signal generator and an antenna. The VSWR sensor can collect VSWR measurements from high-frequency signals sent by the signal generator via the transmission line. The control circuit logic can identify a variation in the VSWR measurements over time and can compare the variation to a threshold value to determine whether an external object near the antenna is animate or inanimate. The control circuit logic can reduce the maximum transmission power level of the antenna when the external object is animate, and can maintain or increase the maximum transmission power level when the external object is inanimate. This can be used to maximize the wireless performance of the electronic device while also ensuring that the device meets the statutory limits for radio-frequency energy exposure.

### SUMMARY

According to a first aspect, the present invention provides a radar transceiver device for radar signals with a frequency-selective radar transmitting unit and/or with a frequency-selective radar receiving unit. According to an example embodiment of the present invention, the frequency-selective radar transmitting unit of the radar transceiver device comprises:

a digital-to-analog converter which is designed to convert a broadband digital signal provided for all transmission channels into an analog transmission signal;

a signal modulator which modulates a signal carrier with the analog transmission signal output by the digital-to-analog converter to generate a modulated transmission signal; and

at least one frequency-selective component which is designed to partition the transmission signal modulated by the signal modulator to a plurality of transmission (TX) channels for radiation as a radar signal; and

wherein the frequency-selective radar receiving unit of the radar transceiver device comprises:

at least one frequency-selective component which is designed to combine a received radar signal comprising a plurality of receive (RX) channels;

a signal demodulator which demodulates the radar signal combined by the frequency-selective component using a signal carrier to generate a demodulated receive signal; and

at least one analog-to-digital converter which is designed to sample the receive signal demodulated by the signal demodulator to generate a digital receive signal.

In the example device according to the present invention, instead of providing one converter per TX channel of a broadband digital radar, a single signal source (DAC) is used which is partitioned to a plurality of TX channels by a frequency-selective TX path / TX antenna. This allows Frequency Division Multiplexing (FDM) with a single signal source (DAC).

Instead of implementing N broadband TX and/or RX channels, the radar transceiver device according to the present invention preferably requires only a single TX and/or RX channel.

In the radar transceiver device for radar signals according to the present invention, the signal division is preferably carried out via passive components.

Depending on the requirements, in the radar transceiver device according to the present invention for radar signals, instead of the TX path the RX path can also be implemented in such a way that only a broadband analog-digital converter has to be used. Furthermore, both paths (TX side and RX side) of the radar transceiver device can be simultaneously implemented to be frequency-selective.

In one possible example embodiment of the radar transceiver device for radar signals according to the present invention, the frequency-selective component has a frequency-selective antenna.

This offers the possibility of a space-saving and efficient implementation of the frequency selectivity.

In one possible example embodiment of the radar transceiver device for radar signals according to the present invention, the frequency-selective antenna comprises a frequency-selective microstrip antenna, a frequency-selective waveguide antenna or a frequency-selective reflector antenna.

In one possible example embodiment of the radar transceiver device for radar signals according to the present invention, the frequency-selective microstrip antenna has a frequency-selective patch antenna with different phase centers per frequency in one dimension.

In one possible example embodiment of the radar transceiver device for radar signals according to the present invention, the frequency-selective microstrip antenna has a frequency-selective spiral antenna with different phase centers per frequency in two dimensions.

For the realization of the radar transceiver device according to the present invention, it is advantageous that the transmitting/receiving element, in particular the frequency-selective antenna, has a frequency-dependent phase center, which in turn can also be realized in periodically or non-periodically repeating fashion. The phase center can be frequency dependent in all three spatial dimensions.

In one possible example embodiment of the radar transceiver device for radar signals according to the present invention, the phase centers are realized in periodically repeating fashion in the frequency domain.

In one possible example embodiment of the radar transceiver device for radar signals according to the present invention, the phase centers in the frequency domain are not realized in periodically repeating fashion.

In one possible example embodiment of the radar transceiver device for radar signals according to the present invention, the frequency-selective microstrip antenna comprises a frequency-selective antenna with a logarithmically periodic arrangement.

In one possible example embodiment of the radar transceiver device for radar signals according to the present invention, the frequency-selective component has frequency-selective signal filters.

These are preferably passive and allow a simple and space-saving implementation of frequency selectivity.

In one possible example embodiment of the radar transceiver device for radar signals according to the present invention, the frequency-selective component comprises a frequency-selective active component.

This can be a signal amplifier. This also enables a simple and space-saving implementation of the frequency selectivity.

In one possible example embodiment of the radar transceiver device for radar signals according to the present invention, the signal modulator is designed to carry out an FMCW modulation of the signal carrier.

FMCW modulation provides a precise method for measuring distances and can provide detailed information about target objects through its continuous modulation and frequency variation.

In one possible example embodiment of the radar transceiver device for radar signals according to the present invention, a local oscillator is provided which generates the signal carrier.

This provides a frequency-stable signal carrier, thus increasing the accuracy of angle and distance estimation.

The present invention further provides a radar apparatus with a radar transceiver device according to the first aspect of the present invention and with a signal processing unit for estimating the angle and/or distance of a target object.

Possible embodiments of the radar transceiver device for radar signals according to the present invention are described in more detail below with reference to the figures.

### BRIEF DESCRIPTION OF THE DRAWINGS

FIG. 1 is a schematic block diagram of a possible example embodiment of a radar transceiver device for radar signals according to the present invention.

FIG. 2A is a diagram illustrating a system design with a frequency-selective transmitting antenna in a possible example embodiment of the radar transceiver device for radar signals according to the present invention.

FIG. 2B is a diagram illustrating a system design with a frequency-selective transmission signal path in another possible example embodiment of the radar transceiver device for radar signals according to the present invention.

FIG. 3 is a schematic representation of a frequency-selective patch antenna with different phase centers per frequency in one dimension.

FIG. 4 is a schematic representation of a frequency-selective spiral antenna with different phase centers per frequency in two dimensions.

FIG. 5A-5D how signal spectra to explain the functioning of possible example embodiments of the radar transceiver device for radar signals according to the present invention.

### DETAILED DESCRIPTION OF EXAMPLE EMBODIMENTS

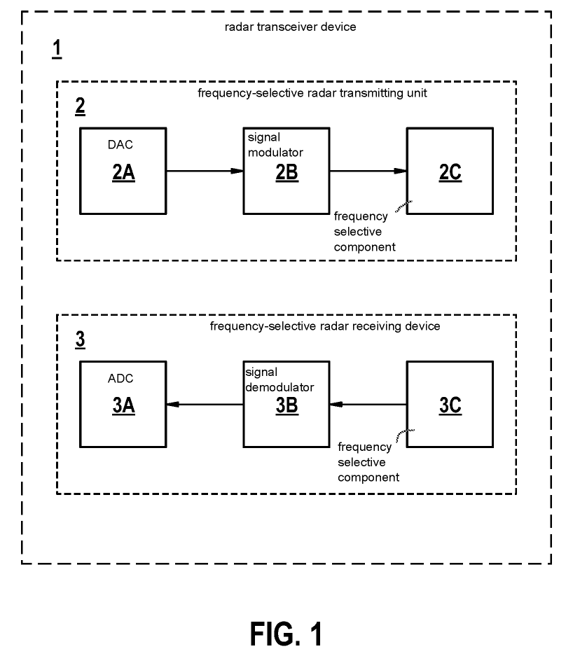

A radar transceiver device 1 according to the present invention for radar signals comprises a frequency-selective radar transmitting unit 2 and/or a frequency-selective radar receiving unit 3, as shown schematically in FIG. 1.

The frequency-selective radar transmission unit 2 of the radar transceiver device 1 comprises a digital-to-analog converter (DAC) 2A, which is designed to convert a broadband digital signal provided for all transmission channels into an analog transmission signal.

The frequency-selective radar transmission unit 2 of the radar transceiver device 1 further comprises a signal modulator 2B which modulates a signal carrier with the analog transmission signal output by the digital-to-analog converter (DAC) 2A to generate a modulated transmission signal.

The frequency-selective radar transmission unit 2 of the radar transceiver device 1 has at least one frequency-selective component 2C which is designed to partition the transmission signal modulated by the signal modulator 2B to a plurality of transmission (TX) channels for transmission as a radar signal.

In one possible embodiment, the radar transceiver device 1 for radar signals according to the present invention also comprises a frequency-selective radar receiving unit 3.

The frequency-selective radar receiving unit 3 of the radar transceiver device 1 comprises at least one frequency-selective component 3C which is designed to combine a received radar signal comprising a plurality of reception (RX) channels.

The frequency-selective radar receiving unit 3 of the radar transceiver device 1 further has a signal demodulator 3B which demodulates the radar signal combined by the frequency-selective component 3C using a signal carrier to generate a demodulated receive signal.

The frequency-selective radar receiving unit 3 of the radar transceiver device 1 further comprises at least one analog-to-digital converter (ADC) 3A which is designed to sample the received signal demodulated by the signal demodulator 3B to generate a digital receive signal.

In one possible embodiment of the radar transceiver device 1 according to the present invention, the frequency-selective component 2C, 3C has a frequency-selective antenna.

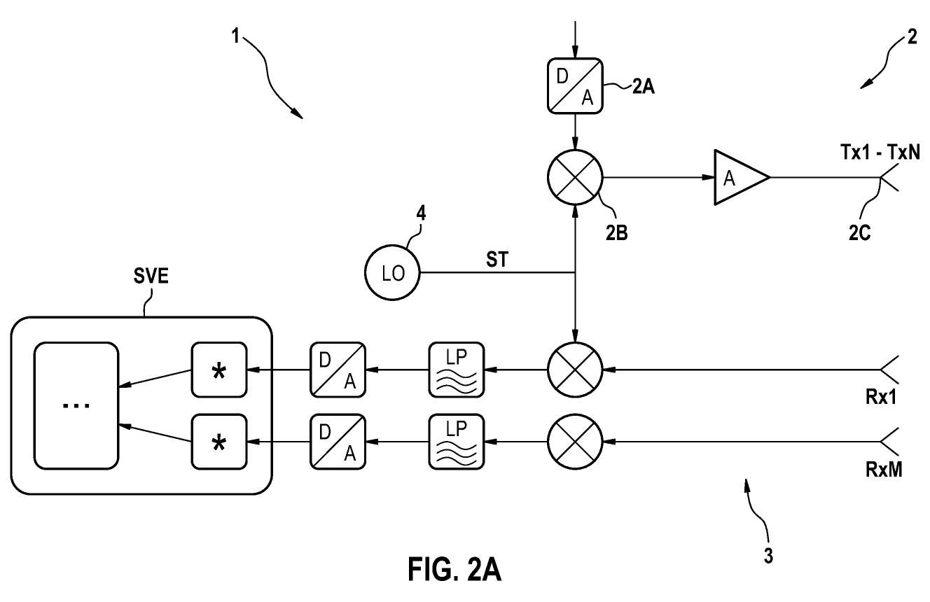

FIG. 2A shows an embodiment of the radar transceiver device 1 with a frequency-selective antenna 2C provided on the transmitter side, which receives a modulated signal from a modulator 2B. The modulated signal can optionally be amplified by a signal amplifier A (amplifier).

In the embodiment shown in FIG. 2A, the transmitter unit 2 is implemented frequency-selectively while the receiver side 3 is constructed conventionally. Each of the M receiving antennas Rx1 to RxM supplies a broadband signal to a demodulator, which sends the broadband signal, demodulated, to an associated analog-to-digital converter ADC via a low-pass filter (LP). The analog-to-digital converter ADC samples the low-pass-filtered demodulated signal and outputs the sample values to a signal processing unit SVE.

A frequency-selective antenna 2C of the radar transceiver device 1 shown in FIG. 1 and FIG. 2A can be implemented differently and comprises, for example, a frequency-selective microstrip antenna, a frequency-selective waveguide antenna, or a frequency-selective reflector antenna.

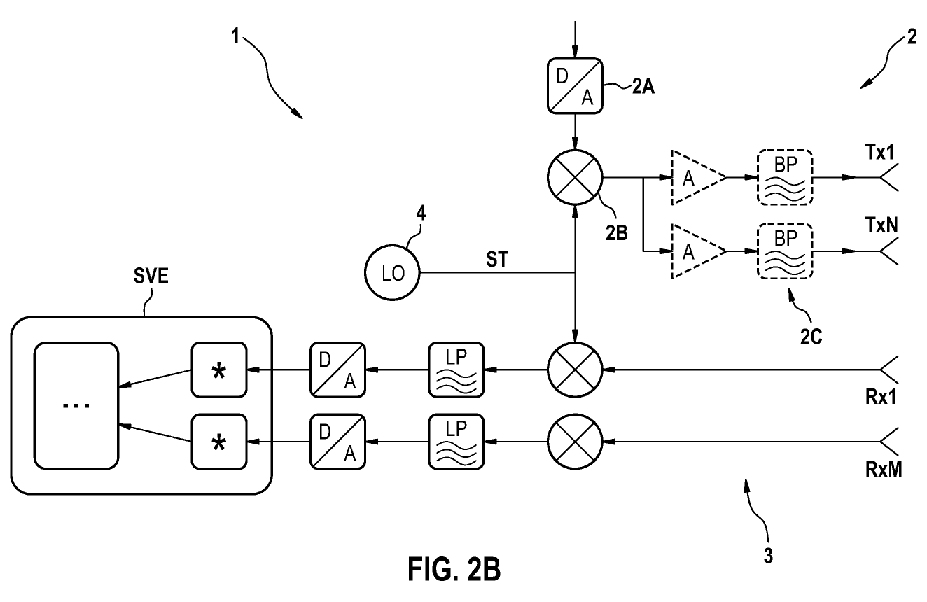

In a possible implementation of the embodiment of the radar transceiver device 1 according to the present invention shown in FIG. 2A, the frequency-selective microstrip antenna 2C has a frequency-selective patch antenna with different phase centers PZ per frequency in one dimension, as shown schematically in FIG. 3.

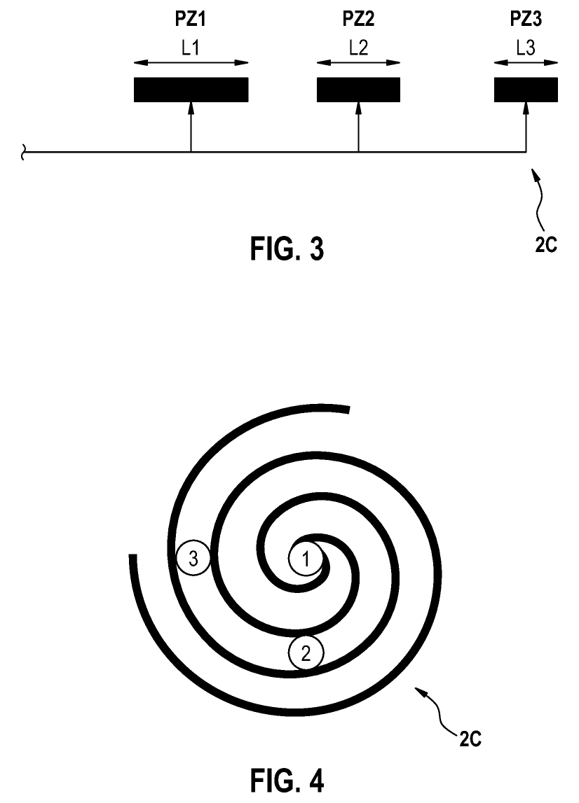

In a further possible implementation of the embodiment of the radar transceiver device 1 according to the present invention shown in FIG. 2A, the frequency-selective microstrip antenna 2C has a frequency-selective spiral antenna with different phase centers PZ per frequency in two dimensions, as shown schematically in FIG. 4.

In one possible embodiment of the radar transceiver device 1 according to the present invention, the phase centers PZ are realized periodically or non-periodically repeating in the frequency domain.

In a further possible embodiment of the radar transceiver device 1 according to the present invention, the frequency-selective microstrip antenna 2C comprises a frequency-selective antenna with a logarithmically periodic arrangement.

In a further possible embodiment of the radar transceiver device 1 according to the present invention for radar signals, the frequency-selective component has frequency-selective signal filters, as shown in FIG. 2B.

FIG. 2B shows a possible embodiment of the radar transceiver device 1 according to the present invention, in which the transmitting side 2 is implemented frequency-selectively by partitioning the signal paths and providing frequency-selective bandpass filters (BP) 2C. Furthermore, signal amplifiers A can optionally be used.

In a further possible embodiment of the radar transceiver device 1 according to the present invention for radar signals, the frequency-selective component 2C, 3C has a frequency-selective active component, in particular a signal amplifier.

In one possible embodiment of the radar transceiver device 1 for radar signals according to the present invention, the signal modulator 2B is designed to carry out an FMCW modulation of the signal carrier ST. In one possible embodiment of the radar transceiver device 1 for radar signals according to the present invention, a local oscillator 4 is provided which generates the signal carrier ST.

In FMCW (Frequency-Modulated Continuous Wave) modulation, the signal carrier ST generated by the oscillator 4 is modulated. The signal carrier ST in the radar transceiver device 1 is a high-frequency signal that acts as the basis for the radar measurements. It is a continuous wave that is sent and received in the radar system to obtain information about distant objects. The frequency f of the signal carrier ST is high and is typically in the gigahertz (GHz) range in order to enable capture of fine details of the target objects. FMCW is a modulation technique in which the frequency f of the continuous carrier signal ST is varied over time. The modulation is continuous and not in pulse form, as is the case with conventional radar systems.

The signal carrier ST is modified by frequency modulation. The carrier signal ST is a continuous, sinusoidal signal with a specific center frequency. The frequency f of the carrier signal ST is changed linearly or non-linearly in a certain time period.

This can be done by a frequency increase (chirp) or a frequency modulation over a period of time. In one possible embodiment, the frequency f of the signal carrier ST is increased linearly during a fixed time interval, the so-called chirp cycle (in a linear FMCW modulation).

FMCW modulation allows the radar apparatus to measure distances and speeds of targets. The process includes transmitting the FMCW signal, wherein a continuous, frequency-modulated carrier is emitted. The emitted FMCW signal hits a target object and is reflected. The radar device receives the reflected signal and compares it with the transmitted signal. The frequency difference between the transmitted and the received signal (the so-called beat signal frequency) is used to calculate the distance and speed of the target object.

In an FMCW radar device with a radar transceiver device 1, the signal carrier ST comprises a continuous high-frequency signal generated by the local oscillator (LO) 4, which is modulated by the modulator 2 B with a varying frequency (FMCW). This modulation allows the radar apparatus to obtain information about the distance and speed of target objects by analyzing the time offset and frequency shift of the reflected signal. The FMCW technique offers a precise method for measuring distances and can provide detailed information about target objects through its continuous modulation and frequency variation.

Broadband digital radar sensors do not yet exist commercially. For this purpose, for each transmission channel (TX) a DAC is conventionally required which generates the analog modulation signal for the modulator 2B, which increases the complexity considerably as the number of TX channels/antennas increases. This can be prevented by implementing frequency selectivity at the transmitter side using a frequency-selective component, such as in the embodiments shown in FIG. 2A, 2B.

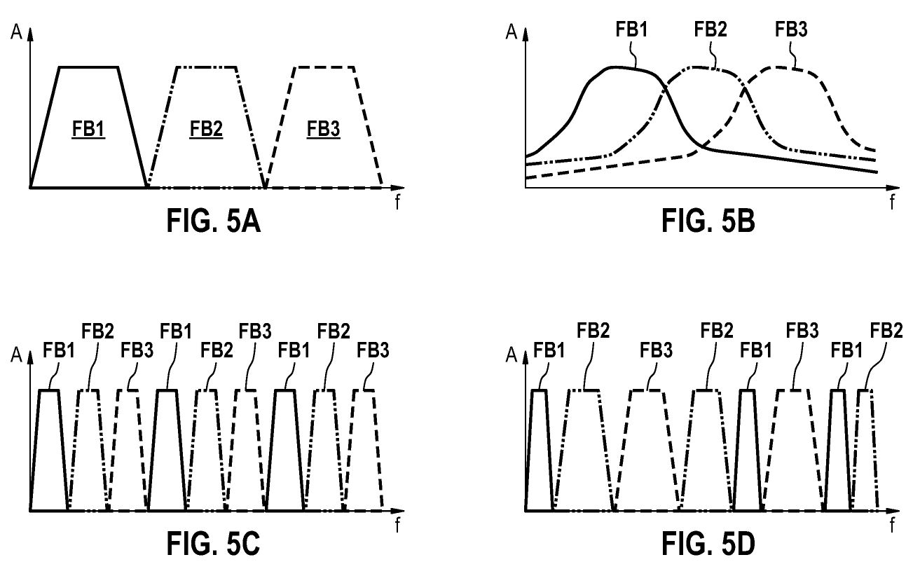

The radar transceiver device 1 according to the present invention, consisting of DACs/ADCs, amplifiers, mixers, filters and antennas, etc., can be designed in various ways to be frequency-selective. Each component in the TX and/or RX path can contribute to frequency selectivity, as schematically shown in FIG. 5A-5D.

FIG. 5A-5D show examples of a possible frequency response of a TX/RX path of the radar transceiver device 1 according to the present invention with three frequency bands FB1, FB2, FB3.

FIG. 5A shows an ideal frequency-selective behavior with three frequency bands FB1, FB2, FB3.

FIG. 5B shows an actual (non-ideal) behavior with non-ideal frequency bands FB.

FIG. 5C shows periodically distributed frequency bands FB while FIG. 5D shows non-periodically distributed frequency bands FB.

The frequency-selective behavior can for example be repeated periodically (FIG. 5C) or non-periodically (FIG. 5D), so that a plurality of components of the broadband signal can be radiated via the same path.

However, it is advantageous for the realization of the radar transceiver device 1 according to the present invention that the transmitting/receiving element, in particular the frequency-selective antenna 2C, has a frequency-dependent phase center PZ, which in turn can also be realized in periodically or non-periodically repeating fashion. The phase center PZ can be frequency-dependent in all spatial dimensions.

The frequency selectivity can be implemented at the transmitting side (TX) and/or at the receiving side (RX) of the radar transceiver device 1 according to the present invention.

Possible embodiments for an implementation at the transmitting side (TX) of a frequency-selective radar transceiver device 1 according to the present invention are described in more detail below.

The frequency-selective radar transmission unit 2 of the radar transceiver device 1 has at least one frequency-selective component 2C which is designed to partition the transmission signal modulated by the signal modulator 2B to a plurality of transmission (TX) channels for transmission as a radar signal.

In one possible embodiment of the radar transceiver device 1 according to the present invention, the frequency-selective component 2C of the frequency-selective radar transmission unit 2 has a frequency-selective antenna. The frequency-selective antenna 2C can for example comprise a frequency-selective microstrip antenna, a frequency-selective waveguide antenna, or a frequency-selective reflector antenna.

In one possible embodiment of the radar transceiver device 1 according to the present invention, the frequency-selective microstrip antenna 2C has a frequency-selective patch antenna with different phase centers PZ per frequency f in one dimension, as shown schematically in FIG. 3.

In a further possible embodiment of the radar transceiver device 1 according to the present invention, the frequency-selective microstrip antenna 2C has a frequency-selective spiral antenna with different phase centers per frequency f in two dimensions, as shown schematically in FIG. 4.

In one possible embodiment of the radar transceiver device 1 according to the present invention, the phase centers PZ are realized periodically or non-periodically repeating in the frequency domain. In the frequency-selective antenna 2C, a broadband signal is applied to an antenna structure. The geometry of the antenna structure results in frequency-dependent phase centers PZ, each of which radiates a different part of the broadband transmission signal into the channel.

For the realization of the radiating elements, in different embodiments of the radar transceiver device 1 according to the present invention the following antenna structures can be used:

- microstrip antennas:

linear patch arrays with different center frequencies (see FIG. 3)

spiral antenna-like arrangement (see FIG. 4)

planar logarithmically periodic arrangement

stacked patch-like arrangements with significantly different resonance frequencies of the individual patches (variation in z direction to extend the FoV towards very large azimuth angle deviations)

- waveguide antennas, e.g. arrangement of waveguide slot radiators with changing slot dimensions (slot length, slot width)

- reflector antennas with frequency-selective reflectivity in different regions of the reflector

FIG. 3 shows a frequency-selective patch antenna 2C with different phase centers PZ per frequency f in one dimension. The patch antenna shown in Fig.3 is a type of microstrip antenna. In one possible embodiment, the patch antenna consists of a conductive patch applied to a dielectric and can be mounted on a grounded rear side. The frequency-selective patch antenna 2C is designed to exhibit different characteristics at different frequencies f. This can be achieved by using different geometric shapes and materials that influence the resonance frequencies of the antenna. Multiple patch elements can also be arranged in specific patterns to produce selective frequency responses.

The phase center PZ of the antenna is the point from which the electromagnetic waves appear to be emitted. In an ideal antenna, the phase center PZ would be the same for all frequencies f. In practice, however, the phase center PZ can vary depending on the frequency f. The patch antenna 2C shown in FIG. 3 is frequency-selective and has different phase centers PZ for different frequencies f. This means that the point from which the waves are radiated changes with the frequency f. This can be influenced by the design of antenna 2C.

FIG. 4 shows a frequency-selective spiral antenna with different phase centers PZ per frequency f in two dimensions. The spiral antenna is a type of broadband antenna that has a spiral structure. It is characterized by its ability to operate over a wide frequency range while offering a constant impedance and directional characteristic. Spiral antennas are suitable for applications that require a large bandwidth.

Frequency selectivity means that the antenna 2C reacts differently at different frequencies f. The phase center PZ of an antenna is the point from which the electromagnetic waves appear to be emitted. If an antenna has different phase centers for different frequencies f, the point from which the waves are emitted changes depending on the frequency. The frequency-selective spiral antenna shown in FIG. 4 is designed to exhibit different radiation characteristics at different frequencies. This antenna structure can be achieved through the geometry of the spiral and the design of the antenna surface.

The spiral antenna shown in Fig.4 preferably consists of a conductive material arranged in a spiral structure. This structure can be Archimedean, logarithmic, or otherwise shaped. The spiral has the property that different frequencies f resonate at different points of the spiral. This has the result that the phase center PZ varies depending on the frequency f. In the frequency-selective spiral antenna shown in FIG. 4, the phase centers PZ can be different in two dimensions (x and y). This means that the position from which the waves are radiated can change along both the x- and y-axis, depending on the frequency f.

In a further possible alternative embodiment of the radar transceiver device 1 for radar signals according to the present invention, the frequency-selective component 2C, 3C has frequency-selective signal filters.

FIG. 2B shows a possible embodiment of the radar transceiver device 1 according to the present invention with a transmitter-side implementation of the frequency selectivity using signal filters, in particular passive bandpass filters BP. When implementing frequency selectivity using filters, a broadband signal is split into a plurality of frequency-selective parallel TX paths, as shown in the embodiment according to FIG. 2B. The parallel Tx paths are radiated via individual antennas Tx1 to TxN. This results in different phase centers PZ for different frequency components. The filter structures of the filters can be realized, for example, using microstrip technology (e.g. hair pin filter, stub pin filter), as a waveguide (e.g. coupled cavity filter with irises) or classically as a lumped element. Depending on the implementation, the signal filter can be located on a different physical component of the device 1. When implemented as a waveguide, it makes sense for example to integrate the structure into a waveguide antenna.

In a possible further embodiment of the radar transceiver device 1 according to the present invention, the frequency selectivity can also be provided in a dynamically adjustable manner using active components. This allows the frequency response to be switched during a measurement, for example, so that additional path combinations are created (classically: more MIMO channels). In one possible embodiment of the radar transceiver device 1 according to the present invention, this can be realized via varactor diodes, RF-MEMS, or variable capacitors with liquid crystals. A combination of a plurality of implementations of the frequency-selective active components is possible.

The system according to the present invention, or the radar transceiver device 1 according to the present invention, can in principle be subdivided into a transmission (TX) path 2 and a reception (RX) path 3. The paths 2, 3 each include, for example, DACs/ADCs, amplifiers, mixers, filters and antennas. The frequency selectivity can be realized either in the TX path 2, in the RX path 3, or in both paths 2, 3 of the radar transceiver device 1 simultaneously.

The possibility of reducing the physically available number of channels then arises for the affected paths. For the TX path of the radar transceiver device 1 the number of parallel TX channels is reduced, for the RX path of the radar transceiver device 1 the number of parallel RX channels is reduced, and for a combined variant of the radar transceiver device 1, parallel TX and RX channels are reduced simultaneously.

When the frequency selectivity is implemented at the transmission side within the radar transceiver device 1 for radar signals according to the present invention, as shown in FIG. 2A, 2B, the TX path 2 is designed to be frequency-selective, so that a broadband signal from, for example, a single signal source 2A (e.g. DAC) is partitioned to a plurality of TX antenna phase centers PZ. This frequency selectivity allows conclusions to be drawn at the receive side about the location of the radiated signal energy, and an angle estimate can be applied to it. This can be for example a correlation, a Fourier transform, or an AI-supported method.

When the frequency selectivity is implemented at the receive side within the radar transceiver device 1 for radar signals according to the present invention, the RX path 3 is designed to be frequency-selective. The broadband TX signal from one or more signal sources is received via a frequency-selective structure with frequency-dependent phase centers (e.g. antenna), combined, and sampled by at least one analog-to-digital converter (ADC). Frequency selectivity allows the receiver to assign a location of the receive signal energy to the TX signals and to apply an angle estimate to it.

The combination of two-sided frequency selectivity, i.e. at both the transmitting side 2 and the receiving side 3, results in a special feature in the signal evaluation by the signal processing unit SVE. Due to the bilateral frequency selectivity, not every TX phase center can be received by every RX phase center. This means that with regard to angle estimation, full MIMO operation is not possible without using a frequency converter in one of the paths. For example, TX and RX phase centers can be designed with the same frequency, so that a 1:1 transmission is realized (classically: a plurality of SISO channels), or overlapping, so that for example a plurality of RX phase centers fit one TX phase center or vice versa (classically: a plurality of SIMO/MISO channels). Furthermore, in addition to the angle estimation, a distance estimation can also be performed based on all receive frequencies, which improves the overall bandwidth and thus the distance resolution.

As a special variant, the TX or RX antenna can be implemented with frequency scanning, so that a targeted controlling with a single or multiple frequencies can be used for example to suppress clutter reflections from other directions, while a broadband controlling illuminates the entire field of view.

Estimation methods based on the frequency selectivity of the radar transceiver device 1 according to the present invention can be carried out. For the angle estimation, MIMO approaches can be used, which are based on the fact that each RX can assign the receive signal to a uniquely identifiable TX. DML methods, correlation, Fourier transformation, or related approaches are then applied. With sharp frequency selectivity, these approaches can be used for the radar transceiver device 1 according to the present invention.

When implementing the radar transceiver device 1 according to the present invention, it can happen that the signals cannot be clearly separated from one another (see FIG. 5B). In addition, the phase centers PZ may merge smoothly into one another, so that each frequency f has its own phase center PZ. Therefore, in this case it is necessary to adapt the signal evaluation. One possible implementation is for example a maximum likelihood method in which the receive signal is compared with a calibration measurement for each angle of incidence. It is also possible to use AI-supported algorithms that realize angle estimation through training.

Alternatively, the broadband nature of the signal generation can also result in pre-distortion, which optimizes the coupling factors between the phase centers PZ in such a way that the signals can again be uniquely assigned to a phase center PZ. The pre-distortion can be implemented analytically or using AI.

Due to the frequency selectivity, it may happen that the full signal bandwidth is not available for evaluation at the receiving end (RX). It is therefore still possible for a plurality of RX paths (or TX paths) to be evaluated together with regard to their RX signal bandwidth. This improves the distance resolution. Since this evaluation may include the influence of the different TX/RX phase centers, it may be necessary to perform a joint distance and angle evaluation and estimate the angle and the distance simultaneously.

What is claimed is:

1. A radar transceiver device for radar signals, comprising:
a frequency-selective radar transmitting unit and/or a frequency-selective radar receiving unit;
wherein the frequency-selective radar transmitting unit includes:
a digital-to-analog converter configured to convert a broadband digital signal provided for all transmission channels into an analog transmission signal,
a signal modulator configured to modulate a signal carrier with the analog transmission signal output by the digital-to-analog converter to generate a modulated transmission signal, and
at least one frequency-selective component configured to partition the transmission signal modulated by the signal modulator to a plurality of transmission channels for radiation as a radar signal; and
wherein the frequency-selective radar receiving unit includes:
at least one frequency-selective component configured to combine a received radar signal including a plurality of receive channels;
a signal demodulator configured to demodulate the radar signal combined by the frequency-selective component using a signal carrier to generate a demodulated receive signal; and
at least one analog-to-digital converter configured to sample the receive signal demodulated by the signal demodulator to generate a digital receive signal.

2. The radar transceiver device for radar signals according to claim 1, wherein the frequency-selective component includes a frequency-selective antenna.

3. The radar transceiver device for radar signals according to claim 2, wherein the frequency-selective antenna includes a frequency-selective microstrip antenna, or a frequency-selective waveguide antenna, or a frequency-selective reflector antenna.

4. The radar transceiver device for radar signals according to claim 3, wherein the frequency-selective microstrip antenna includes a frequency-selective patch antenna having different phase centers per frequency in one dimension.

5. The radar transceiver device for radar signals according to claim 3, wherein the frequency-selective microstrip antenna includes a frequency-selective spiral antenna having different phase centers per frequency in two dimensions.

6. The radar transceiver device for radar signals according to claim 4, wherein the phase centers are realized periodically or non-periodically repeated in the frequency domain.

7. The radar transceiver device for radar signals according to claim 3, wherein the frequency-selective microstrip antenna includes a frequency-selective antenna having a logarithmically periodic arrangement.

8. The radar transceiver device for radar signals according to claim 1, wherein the frequency-selective component includes frequency-selective signal filters.

9. The radar transceiver device for radar signals according to claim 1, wherein the frequency-selective component includes a frequency-selective active component.

10. The radar transceiver device for radar signals according to claim 1, wherein the signal modulator is configured to carry out an FMCW modulation of the signal carrier.

11. The radar transceiver device for radar signals according to claim 1, wherein a local oscillator is provided which generates the signal carrier.

12. A radar apparatus, compriisng:
a radar transceiver device; and
a signal processing unit for angle and/or distance estimation of a target object;
wherein the radar transceiver device includes:
a frequency-selective radar transmitting unit and/or a frequency-selective radar receiving unit;
wherein the frequency-selective radar transmitting unit includes:
a digital-to-analog converter configured to convert a broadband digital signal provided for all transmission channels into an analog transmission signal,
a signal modulator configured to modulate a signal carrier with the analog transmission signal output by the digital-to-analog converter to generate a modulated transmission signal, and
at least one frequency-selective component configured to partition the transmission signal modulated by the signal modulator to a plurality of transmission channels for radiation as a radar signal; and
wherein the frequency-selective radar receiving unit includes:
at least one frequency-selective component configured to combine a received radar signal including a plurality of receive channels;
a signal demodulator configured to demodulate the radar signal combined by the frequency-selective component using a signal carrier to generate a demodulated receive signal; and
at least one analog-to-digital converter configured to sample the receive signal demodulated by the signal demodulator to generate a digital receive signal.
